(19) United States
(12) Patent Application Publication
(10) Pub. No.: US 2025/0187250 A1
(43) Pub. Date: Jun. 12, 2025

(54) Method and apparatus for producing plastic containers

(71) Applicant: KRONES AG, Neutraubling (DE)

(72) Inventors: Stefan JANSEN, Gronau (DE); Thomas BOCK, Hemau (DE)

(21) Appl. No.: 18/974,561

(22) Filed: Dec. 9, 2024

(30) Foreign Application Priority Data
Dec. 8, 2023 (DE) 10 2023 134 377.7

(51) Int. Cl. B29C 49/78; B29C 49/42; B29C 49/64; B29L 31/00

(52) U.S. Cl. CPC B29C 49/78; B29C 49/42065; B29C 49/6418; B29C 2049/78755; B29L 2031/7158

(57) ABSTRACT

Plastic preformed having a main body, a mouth, and a support ring, are transported along a predetermined transport path and heated using at least one heating device, and, subsequently, the heated plastic preforms are transported to a forming device for forming plastic preforms into plastic containers and are formed into the plastic containers by applying a flowable medium, wherein at least one value is determined using an inspection device, which value is characteristic of at least one physical and in particular geometric property of a support ring of a plastic preform and/or of a plastic container, and at least one treatment parameter of the heating device and/or of the forming device is controlled taking this value into account.

### BACKGROUND OF THE INVENTION

The present invention relates to an apparatus and a method for producing plastic containers, such as, in particular, but not exclusively, beverage bottles.

It has long been known from the prior art that plastic preforms are heated, and, subsequently, these plastic preforms are formed and in particular expanded into plastic containers and in particular plastic bottles using forming devices such as, for example, stretch blow molding machines. Subsequently, the produced containers are filled and provided with a closure.

A substantial element of these plastic preforms is the so-called support ring or neck ring. This serves in particular to transport the plastic preforms, but also to transport the plastic bottles made from them.

This support ring is arranged in a region of the mouth of the plastic preforms. During production, it is common for a main body of the plastic preforms to be heated, but not the threaded region, on which a closure is later to be placed.

Accordingly, the support ring is also a critical element in the production of plastic preforms. If this is deformed, closing the plastic containers becomes more difficult or is no longer possible in some cases.

In some cases, it is also known in the prior art to use this support ring as a reference plane during an inspection of the closure-for example, in order to evaluate the high seating or misalignment of a closure arranged on the container.

This is only a reaction to a possible deterioration in quality, but preventive measures are not taken to prevent or counteract such a deterioration.

Therefore, in the prior art, the problem sometimes arises that containers with a deteriorated quality have already been produced before a control system, such as a blow molding machine or a heating tunnel or, in general, a heating device, reacts to this.

If the temperature of the plastic preforms is too high, it can result in a forming device, such as a stretch blow molding machine, deforming the neck of the container. For example, the support ring in question can be bent upwards (which can happen, for example, as the result of the placement of the blower nozzle).

In addition, the indentation beneath the support surfaces (of the support ring), which is intended to prevent the container from rising when held by a clamp gripping it from below, is increasingly disappearing.

If the support ring is bent upwards, it can happen that the closures stand up on the support ring when closing. As a result, they are compressed or twisted, which in turn leads to the inspection of the closure detecting a misalignment of the closure.

The present invention is based upon the object of improving such apparatuses and methods with regard to their susceptibility to errors. In addition, the present invention is based upon the object of providing an apparatus and a method which make possible a faster reaction to errors that arise, or even a pro-active correction.

### SUMMARY OF THE INVENTION

In a method according to the invention for producing plastic containers, plastic preforms are transported along a predetermined transport path, wherein these plastic preforms have a main body, a mouth, and a support ring, and the main bodies of the plastic preforms are heated using at least one heating device, and, subsequently, the heated plastic preforms are transported to a forming device for forming plastic preforms into plastic containers, and the plastic preforms are formed into the plastic containers by applying a flowable and in particular gaseous medium.

According to the invention, at least one value is determined using an inspection device, which value is characteristic of at least one physical and in particular geometric property of a support ring of a plastic preform and/or a plastic container (in particular, a plastic container manufactured from a plastic preform), and at least one treatment parameter of the heating device and/or the forming device is controlled taking this value into account.

For example, it is possible to assess the quality of the blown containers (resulting from the heating process) based upon the (relative) measured closure height, and to adjust the heating and/or blowing process accordingly.

In a preferred method, a transport device transports the plastic preforms from the heating device to the forming device. Particularly preferably, this transport device is one or more transport starwheels that transport the plastic preforms. Particularly preferably, the plastic preforms are transported at least in portions on circular-segment-shaped transport paths.

Particularly preferably, a pitch and/or a spacing of successive plastic preforms is changed during the transport of the plastic preforms from the heating device to the forming device. Particularly preferably, a pitch adjustment is thus carried out.

Particularly preferably, the plastic preforms are formed into plastic containers by applying a gaseous medium, and in particular, blown air.

In a further preferred embodiment, the plastic preforms are stretched in their longitudinal direction. For this purpose, rod-like bodies, so-called stretching rods, are inserted into the plastic preforms in order to stretch them in their longitudinal direction.

Particularly preferably, a flowable and in particular gaseous medium, such as in particular but not exclusively blown air, is applied to these plastic performs via their mouth. Preferably, an application device, in particular a blowing nozzle, is applied to a mouth region of the plastic preforms or the support ring or a blow mold, within which the plastic preform is located in order to apply the gaseous medium to these plastic preforms. Preferably, pressure is exerted on the plastic preforms in their longitudinal direction through this application device.

Particularly preferably, the plastic containers produced in the forming device or in the individual forming stations of this forming device are filled and preferably then closed. This closing is preferably effected using a screw closure, which is screwed onto a thread of the plastic containers and in particular onto an external thread of the plastic containers.

In a further preferred method, the containers to be inspected are rejected from a transport path of the containers and, in particular, from a transport path along which the plastic preforms are transported from the heating device to the forming device. This means that preferably not all plastic containers are inspected, but only some, and these are checked in particular on a random basis. This inspection can be effected at specified intervals or in each case after a predetermined number of containers or plastic preforms.

In a further preferred method, the containers or some of these containers transported from the forming device to a downstream device, such as a filling device, are inspected.

In a further preferred method, a point in time at which a particular container is inspected and/or rejected from a transport path is detected.

In a preferred method, the value characteristic of at least one physical property of a support ring of a plastic preform and/or a plastic container is selected from a group of values that comprise a direction of extension of the support ring relative to a longitudinal direction of the plastic preform, a wall thickness of the support ring, a curvature of the support ring, in particular the presence of such a curvature in relation to a predetermined plane and in particular a plane that is spanned by a longitudinal direction of the plastic preform and a radial direction, a concentricity of the support ring relative to an axis of symmetry of the plastic preform, a radius of the support ring, a distance of the support ring to a closure arranged on the plastic preform, a distance of the support ring to a thread of the plastic preform, and the like.

In a further preferred method, the value that is characteristic of at least one physical property of a support ring of a plastic preform and/or a plastic container is characteristic of a distance between a reference point on the plastic container, in particular the support ring, and a further reference point (or is such a value). Particularly preferably, the further reference point is arranged on the plastic container or on the container closure.

From such a distance, it can be determined whether the support ring is positioned in a target position relative to other regions of the closure or relative to other regions of the plastic container.

It would also be possible to define several such further reference points
for example, a reference point that is also located on the container closure and a reference point that is located on the plastic container. It would also be conceivable to define reference lines on the container closure or the plastic container instead of or in addition to reference points—for example, reference lines that run horizontally (when the container is upright).

Preferably, the inspection device has at least one image-recording device that records at least one image of a plastic preform to be inspected, in order to determine said value. Preferably, this image-recording device records an image of the plastic preform in a direction that has at least one component that is perpendicular to a longitudinal direction of the plastic preform. For example, an image of the plastic preform or the container can be recorded at an angle from below, in order to depict the support ring.

Preferably, the plastic preform is illuminated for the purpose of this image recording and, in particular, illuminated by white light. Particularly preferably, at least one image of the plastic preform is recorded using the reflected light method.

In a further preferred method, a closure is arranged on at least one plastic container, wherein this closure preferably is screwed onto a thread of the plastic preform. Particularly preferably, this closure is screwed up to a maximum closure rotation angle.

Particularly preferably, the plastic container provided with the closure is inspected, and at least one value is detected which is characteristic of a geometric relationship between the plastic container and the closure arranged on the plastic container, wherein this geometric relationship preferably is a geometric relationship of at least one portion of the closure or of the plastic container to the support ring of the plastic container.

In a further preferred method, a target value is determined for the above-mentioned value. Particularly preferably, this target value is determined outside a production operation.

In a preferred method, a closure is arranged on at least one plastic preform (in particular for the purpose of determining this target value), wherein this closure preferably is screwed onto a thread of the plastic preform and preferably the plastic preform provided with the closure is inspected, and at least one value is detected which is characteristic of a geometric relationship between the plastic preform and the closure arranged on the plastic preform, wherein this geometric relationship preferably is a geometric relationship of at least one portion of the closure or of the plastic container to the support ring of the plastic preform.

However, the target value can also be determined in another way—for example, manually by a machine operator. The target value can also be specified by a user input. The target value can also be retrieved from a memory device, for example, in which such target values are stored for specific plastic preforms.

Prior to production (in particular, prior to continuous operation and/or production operation), the optimum distance between the support ring (in particular, based upon a plastic preform that has not yet been blown) and a reference value, in particular a reference position, in particular the closure (or the plastic container), is preferably measured in order to specify a target value. This can be effected upstream of the furnace, for example. Alternatively, it would also be conceivable that this distance be measured by an operator and stored in the machine.

In a subsequent continuous operation or production mode, the distance between the support ring (but now from the blown plastic container) and the closure is measured and compared with the target value. Following this, the apparatus is preferably controlled and in particular regulated based upon this comparison and, in particular, the result of this comparison. This further measurement is preferably effected after the closing process.

If the temperature of the plastic preforms is generally too high, the stretch blow molding machine can deform the neck of the bottle. The support ring is bent upwards, for example. Likewise, the indentation under the support ring, which is intended to prevent the container from rising, disappears more and more, in particular if it is held from below with a clamp.

If the support ring is bent upwards, the closures can stand up on the support ring when closing. As a result, they are compressed or twisted, which in turn can lead to the inspection of the closure detecting a misalignment of the closure.

In a further preferred method, the plastic preform provided with the closure is inspected, and at least one value characteristic of a geometric relationship between the plastic preform and the closure arranged on the plastic preform is detected, wherein this geometric relationship preferably is a geometric relationship of at least a portion of the closure to the support ring of the plastic preform. For example, a distance between a lower edge of the closure and the support ring can be detected, in particular in the longitudinal direction of the plastic preforms.

The height of a feature on the closure can also be detected, in addition or as an alternative. As mentioned above, this test can be carried out on a random basis on individual plastic preforms or on all of them. In a further preferred method, this inspection is carried out during ongoing operation. As mentioned above, it is also possible to carry out this inspection offline.

In a further preferred method, at least one value characteristic of the operation of the heating device and, in particular, an environmental value is measured, wherein the forming device and/or the heating device preferably is controlled and/or regulated taking this value into account.

In the method described above, environmental parameters are also preferably determined. These data are preferably stored (in particular in a database). Based upon this data, correlations can be formed between all the parameters determined (in particular using artificial intelligence). In the best case, for example, it is known that, for example, the ambient temperature X has a specific influence on the heating behavior of the plastic preform, and that this can lead to a bending of the support ring or can do so with a specific probability.

These data can now be used to regulate and/or control the forming apparatus and/or the heating device in advance, before bending occurs. This reduces the reject rate.

This would make it possible to control individual heating elements of the heating device in order to adjust the heating of the plastic preforms. Preferably, several heating elements, in particular stationary heating elements, are provided along a transport path of the plastic preforms, past which the plastic preforms are transported.

Preferably, several radiant heaters are provided along the longitudinal direction of the plastic preforms, which heaters are preferably controlled individually in order to be able to adjust the heating power in the longitudinal direction of the plastic preforms.

In a further preferred method, at least one value characteristic of the operation of the forming device and in particular an environmental value is measured, and the heating device and/or the forming device is preferably controlled taking this value into account.

This method is based upon the idea that the heating device and the forming device work together, and that parameter changes in one or both apparatuses can also affect the downstream apparatus.

It should be noted that this method, with which the environmental value is determined, can also be applied independently of the above-mentioned method, with which the support ring is inspected.

Therefore, the applicant reserves the right to claim protection for a method for producing plastic containers, wherein plastic preforms are transported along a predetermined transport path, and these plastic preforms have a main body, a mouth, and a support ring, and the main bodies of the plastic preforms are heated using at least one heating device, and, subsequently, the heated plastic preforms are transported to a forming device for forming plastic preforms into plastic containers and are formed into the plastic containers by applying a flowable medium, wherein, according to the invention, at least one value characteristic of the operation of the heating device and, in particular, an environmental value is measured, wherein the forming device and/or the heating device preferably are controlled and/or regulated taking this value into account.

The forming device, in particular a blowing machine, and also the heating device, in particular a heating tunnel, is therefore preferably equipped with an environment sensor system, which records the relevant influences-for example, on the measured closure height. These influences can, for example, be the ambient temperature, humidity, temperature of the plastic preforms, degree of absorption of the plastic preforms, ambient air pressure, and the like.

Preferably, an artificial intelligence (AI) is used for this purpose, which preferably changes the heating process and/or the blowing process (in particular proactively) in response to changing input variables, or adjusts it in such a way that there is no change and, in particular, no deterioration in the neck quality.

In this way, no containers with a poor neck quality are produced. Due to higher and/or more consistent quality, better transport of the plastic preforms through the machine is also achieved.

Particularly preferably, this environmental value is selected from a group of values that contain an ambient temperature, an air humidity, an air pressure, a temperature of the plastic preforms prior to their heating, a temperature of the plastic preforms after their heating, a temperature of the plastic preforms during their heating, a temperature profile of the plastic preforms during their heating, a temperature of the outer wall of the plastic preforms, a temperature of the inner wall of the plastic preforms, a degree of absorption of the plastic preforms, in particular for infrared radiation and/or microwaves, a temperature profile of the plastic preforms with respect to the longitudinal direction, a temperature profile of the plastic preforms with respect to their circumferential direction, and the like. Particularly preferably, several of these values are determined.

In the further preferred method, at least one working parameter is assigned to a container or the inspected container, preferably the working parameters by which this container was treated (and in particular heated and/or formed). Particularly preferably, the inspected container is identified.

In a further preferred method, the inspected container is assigned the environmental data and/or the measurement data by which this container was treated, in particular by identification information. In particular, these are environmental data or measurement data that are characteristic of parameters by which this container or the plastic preform was heated.

In a further preferred method, a model is created which combines production data (in particular, working parameters and/or environmental data and/or measurement data) and the value characteristic of a support ring of the plastic preform.

In a further preferred method, the manufactured plastic container is also inspected. It is possible to determine at least one parameter that is characteristic of at least one physical property of the support ring.

Preferably, the container is inspected in an unclosed and/or unfilled state. In a further preferred method, the filled container provided with a container closure is inspected.

Particularly preferably, measurement values characteristic of this treatment are also recorded during the treatment of the container and/or the plastic preform. These measurement values can, for example, be measured pressure values, measured flow values, temperatures, radiator outputs of radiant heaters of the heating device, and the like. These measurement values are also preferably detected.

In a further advantageous method, a plurality of containers are inspected and, preferably, a model for controlling the treatment device and/or the heating device and/or the forming device is derived from the measurement values determined during these inspections, in particular the measurement values that are characteristic of the support rings and/or the physical properties of the support rings.

Preferably, all available data from a largest possible number of containers and a wide variety of production data and/or environmental data and/or measurement values (in particular of the measurement values characteristic of the physical properties of the support rings) are brought together and/or assigned to one another, and a model is preferably formed therefrom.

Various options can be considered for the modeling. For example, classic correlation analyses or dimensional analyses can be carried out. Relationships can also be modeled using mathematical fitting functions.

A model can also be generated with the help of an expert. Also conceivable are various AI methods, such as a neural network, reinforcement learning, or physically based AI, which generate a model.

Preferably, the determining of working parameters and/or environmental parameters is effected using an (artificial) neural network and, in particular, using (computer-implemented) machine learning methods based upon at least one, and in particular exactly one, (artificial) neural network. Preferably, the simulation container inspection model of machine learning is based upon an (artificial) neural network.

The data that flow in the model can be generated during standard production or in special production runs in which specific parameters are specifically varied. It is also conceivable to combine both methods and to generate a basic set of data for a basic model in a “teaching run,” and then gradually feed data into the system during ongoing production and, if necessary, refine the model.

The neural network is preferably formed as a deep neural network (DNN), in which the parameterizable processing chain has several of processing layers, and/or a so-called convolutional neural network (CNN) and/or a recurrent neural network (RNN).

The data (to be processed), in particular the sensor data (or data derived therefrom) and/or the data from the inspection device, are preferably fed as input variables to the model or the (artificial) neural network. The model or the artificial neural network preferably maps the input variables, dependent upon a parameterizable processing chain, to output variables, wherein the measured variables preferably are selected as the output variable, and preferably a plurality of measured variables are selected as output variables.

Preferably, the plant now adjusts the performance of the containers and in particular the physical properties of the support rings to the target performance and in particular to the target properties of these support rings, in particular on the basis of the existing model, during the production run (or during short breaks).

For this purpose, the treatment device, in particular the heating device and/or the forming device, preferably attempts to adjust the controllable production data in such a way that the desired performance and/or the desired shape of the support rings is achieved.

When it comes to production data, a distinction is preferably made between three different types of data and/or parameters, namely, on the one hand, data or parameters that can be directly influenced (e.g., machine speed or filling pressure or heating power), parameters that can be indirectly influenced (wall thickness distribution, preform temperature at the furnace outlet, or filling level or the properties of the support rings, such as their dimensions or height position), and values that cannot be influenced (air humidity, IR absorption behavior, or hall temperature).

In order to achieve the desired target performance and/or target states, in particular with regard to the support ring, various cascaded models can be used. For example, it is conceivable that there be a model that adjusts an indirectly controllable variable (e.g., wall thickness distribution, or characteristic properties of the support ring) by adjusting directly controllable values (e.g., heating disk, heating devices, or stretching speed or blowing pressures) in such a way that the configuration of the support ring stored in the main model is generated for the current hall temperature in order to achieve the target performance.

A further point that can preferably be included in the model is secondary conditions such as energy requirements or filling pressure or a force with which a blow nozzle is placed on the plastic preforms to be expanded. For example, an attempt can be made to get as close as possible to the target performance with minimal energy consumption.

It is also conceivable that the model will be gradually refined by continually collecting performance data and comparing them with the model forecast data.

The present invention will now be explained using a specific example, namely a blow-molding machine. Such blow-molding machines have a rotatable transport carrier on which a plurality of forming stations are arranged, which form plastic preforms into plastic containers. Furthermore, these machines preferably also have stretching units which stretch the plastic preforms in their longitudinal direction. Preferably, these machines also have process controls that regulate the forming processes in particular individually for each forming station.

In addition, as mentioned above, these machines preferably have heating devices which heat the plastic preforms.

During the process determination or validation of the container quality and/or the properties of the support rings, several of sample bottles and/or sample preforms are preferably rejected and subsequently subjected to online quality tests or, in particular, offline quality tests. Optimization loops are preferably run, and preferably iterative optimization loops are run until the quality tests are found to be good.

If it turns out that the best result was already found at the beginning of this optimization loop and no further improvement could be found afterwards despite prolonged efforts, these initial results would also be accepted as a compromise.

In this case, the problem can arise in the prior art that the associated setting parameters and, if applicable, online measurement values such as measurements of the wall thickness of the plastic preforms and the like for this “best result” are no longer known or have not been saved.

In the following, offline measurements are understood to mean measurements of containers and/or plastic preforms that are carried out outside of a production plant and that ultimately serve to prove whether the container and/or a plastic preform and/or a support ring of a plastic preform or a plastic container meets the required quality standards. These measurements include, for example, measurements of the section weights, thermal tests, optical measurements, in particular with regard to the support ring, and the like

Online measurements are understood to mean measurements that can be carried out during production and in particular without rejecting containers and/or plastic preforms (such as wall thickness measurements, optical measurement methods for molding and stretching, optical measurements of the support ring, and the like).

If these measurements correlate sufficiently well with the actual quality requirements, offline measurements can be reduced or eliminated completely.

However, as mentioned above, offline measurements and online measurements that were carried out on the same container or the same group of containers are also assigned to one another.

In a further preferred method, both offline measurements, i.e., measurements with which the containers are rejected, and online measurements, carried out during production operation, are taken. Preferably, identification information can be specified or output both for these offline measurements and for online measurements.

Optional identification information (also known as a reject ID) prevents good settings from being lost and process work having to be carried out several times. Since the offline quality measurements often run parallel to container optimization, it can easily happen that good intermediate results are simply lost again, since the associated setting parameters were not saved. In difficult cases, it can happen that, due to minor issues, the customer initially insists on further optimization, but ultimately ends up accepting the previously rejected intermediate result.

A requirement for consistent quality for all containers and/or all support rings is generally almost impossible to fulfill afterwards, since, on the one hand, the associated conditions can no longer be reconstructed and, on the other hand, the information is sometimes available only in the form of measurement data, since the measurement methods were not non-destructive.

In a preferred method, such plastic preforms or containers that are to be inspected are assigned identification information-for example, a reject ID.

If a reject ID or the identification information is assigned to the containers and/or plastic preforms, as proposed in a preferred method, the complete setting parameters of the forming apparatus, along with the associated online measurement data for these containers and/or plastic preforms, can be transferred from the database back into the machine and into the measuring unit solely via this identification information, in particular in conjunction with an associated time stamp.

In the following, a control target refers to the online measurement results, such as the geometric position of the support ring and/or a distance between a support ring and a closure and/or a mouth, which are preferably stored in the control system as target values. Process specifications carried out by the control system aim to reach this control target as well as possible.

The identification information or the reject ID makes it possible to exactly match the online control target with the “best offline measurement data.” Currently, the target values of the online measurement data are recorded by the measuring system during the teach-in phase (DoE (statistical design of experiments)) and are then passed on to the control system.

These are preferably not identical to the values that were achieved in the validation process, but “only” those online measurement values that result from repeating the best setting parameters (best setpoint settings) from the validation process in the teach-in phase (DoE).

Since the disturbing influences to be regulated out can also lead to a deterioration in container quality and/or the quality of the support rings even with identical setting parameters, there is a risk that the best possible wall thickness distribution from the validation process will not be stored as the control target during the teach-in phase, but, rather, if applicable, a less favorable wall thickness profile will be stored. The control target would therefore be worse than desired by a customer.

However, if the corresponding identification information is available for the test containers rejected in the validation process, not only the complete setting parameters of the stretch blow molding machine and/or the heating device (best setpoint settings), but also the associated online measurement data for these containers and/or plastic preforms can be transferred from the database alone, in conjunction with the associated time stamp data, back to the measuring unit and into the control system as a perfect control target.

In a further preferred method, the identification information is stored or written together with a time stamp in the database data, in particular the DMM (data management machine) data.

Therefore, as mentioned above, in a further preferred method, a point in time at which a specific container and/or a specific plastic preform is inspected and/or rejected from a transport path is detected.

As mentioned above, the identification information preferably contains a time stamp or a feature characteristic of a point in time. Preferably, the identification information is stored with a time stamp.

In a preferred method, a model is created that combines production data (work parameters and/or environmental data and/or measurement data) and performance data. Preferably, the container performance (and/or the quality of the support ring) is optimized based upon production data and the model in (real) time.

In a preferred method, the production data, preferably working parameters, are therefore adjusted based upon the model, in order to achieve optimum performance data and/or optimum properties of the support ring.

In a further preferred method, the identification information is generated and/or can be generated by user intervention. Therefore, it is possible that the identification information not be generated automatically or by default, but only if the user so wishes.

Preferably, the rejection of the containers for the purpose of inspection is separated from the conventional rejection (for example, of faulty containers).

Preferably, the identification information is kept short. For example, the identification information can contain a date and a sequence number (wherein the sequence number is preferably restarted every day). In addition, an index (a, b, c, . . . ) can also be provided.

If many offline tests are required, several of rejections may be necessary when rejecting an operating state.

In the case of larger (and/or several) rejections, the index (a, b, c, . . . ) should be added.

This should preferably only be possible if the rejections are effected within a short time—for example, within two minutes.

Preferably, the determined data can be stored both in a cloud-based database and in a customer-side and/or local database.

Preferably, the characteristic value is a property that can be determined by inspection and that allows conclusions to be drawn about the treatment or the treatment process.

In a further preferred method, the working parameters are adjusted based upon the model in order to achieve improved power data and/or performance data (in particular with regard to the support ring). In particular, the working parameters are adjusted in order to improve the actual position and/or the actual shape of the support ring, or to bring it closer to the target position.

In a further preferred method, a plurality of containers are inspected, and a model for controlling the treatment device and in particular the heating device and/or the forming device is derived from the measurement values determined during these inspections. This can be effected in the manner described above.

In a further preferred method, the plastic containers produced by the forming device are inspected, and at least one value characteristic of a support ring of a plastic container is determined. With this configuration, the containers are inspected after the forming process, and values that are characteristic of the support ring are derived from this inspection.

The present invention is further directed at an apparatus for producing plastic containers, which has a transport device that is suitable and intended for transporting plastic preforms along a predetermined transport path, wherein these plastic preforms have a main body, a mouth, and a support ring, and furthermore a heating device is provided, which is suitable and intended for heating the main bodies of the plastic preforms and having a forming device for forming plastic preforms into plastic containers, which is suitable and intended for forming the heated plastic preforms into the plastic containers by applying a flowable and in particular gaseous medium to them.

According to the invention, an inspection device is provided which is suitable and intended for determining at least one value that is characteristic of at least one physical property of the support ring of a plastic preform and/or a physical property of the support ring of a plastic container, and a control device is provided which is suitable and intended for controlling at least one treatment parameter of the heating device and/or the forming device, taking this value into account.

It is therefore also proposed on the apparatus side that an inspection device be provided which observes the support ring, and from this the values be derived, by which the heating device and/or the forming device are controlled.

Preferably, the heating device is formed in such a way that it heats the main bodies of the plastic preforms, but not or only to a significantly reduced extent the mouths, threads, and/or support rings of the plastic preforms. Preferably, the apparatus has a shielding device which is suitable and intended to prevent the heating of the support rings and/or the mouth regions of the plastic preforms.

In a further advantageous embodiment, the apparatus has at least one sensor device that is suitable and intended for measuring and or determining at least one value characteristic of the operation of the heating device and/or the operation of the forming device and, in particular, an environmental value.

Particularly preferably, the heating device and/or the forming device can be controlled taking this value into account.

In a further advantageous embodiment, the apparatus has a closing device for closing the containers, and the inspection device is arranged downstream of this closing device in a transport direction of the plastic containers.

It would also be conceivable that the inspection device be arranged after the closing (i.e., after the actual closing process), but still in the closing device. This is also regarded as an arrangement downstream of the closing device.

Particularly preferably, the apparatus has a filling device for filling the plastic preforms.

In a further preferred embodiment, the apparatus has a comparison device that is suitable and intended for comparing the value with a target value and/or reference value.

### BRIEF DESCRIPTION OF THE DRAWINGS

Further advantages and embodiments can be seen in the accompanying drawings, in which:

FIG. 1 is a representation of an apparatus according to the invention; and

FIG. 2 consists of two representations for visualizing the problem underlying the invention.

### DETAILED DESCRIPTION OF THE INVENTION

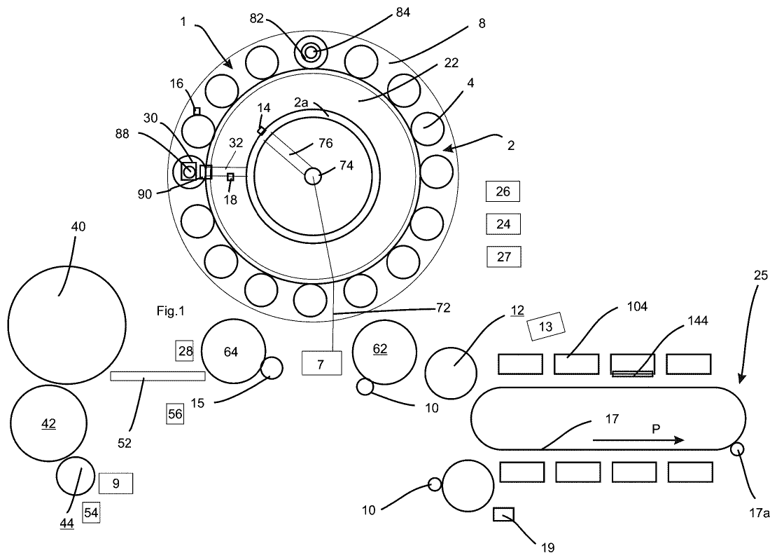

FIG. 1 shows an apparatus 1 for forming plastic preforms 10 into plastic containers 15. In this case, this is also the treatment device for treating containers. This apparatus 1 has a rotatable carrier 22 on which a plurality of forming stations 4 are arranged. These individual forming stations each have blow-molding devices 82, which in their interior form a cavity for expanding the plastic preforms.

Reference sign 84 designates an application device which serves for expanding the plastic preforms 10. This can be a blow nozzle, for example, which can be applied to a mouth of the plastic preforms in order to expand the latter. In addition, it is also conceivable to seal the blowing nozzle on the blow-molding device. Preferably, this application device is movable in a longitudinal direction, and preferably exclusively in a longitudinal direction of the plastic preforms.

Reference sign 90 designates a valve arrangement, such as a valve block, which preferably has a plurality of valves that control the application of different pressure levels to the plastic preforms. Each forming station preferably has such a valve block.

In a preferred method, first a pre-blowing pressure P1, then at least one intermediate blowing pressure Pi that is higher than the pre-blowing pressure, and finally a final blow molding pressure P2 that is higher than the intermediate blowing pressure Pi are applied to the plastic preforms. After expansion of the plastic containers, the pressures or compressed air are preferably returned from the container to the individual pressure reservoirs. Preferably, a further pressure stage, in particular a further intermediate blowing pressure, is provided.

Reference sign 88 designates a stretching rod which serves to expand the plastic preforms in their longitudinal direction. Preferably, all forming stations have such blow molds 82 as well as stretching rods 88. This stretching rod is preferably a component of a stretching device designated by 30. The stretching rod is (preferably, also exclusively) movable in the longitudinal direction of the plastic preforms 10.

Preferably, the number of such forming stations 4 is between 2 and 100, preferably between 4 and 60, preferably between 6 and 40.

The plastic preforms 10 are fed to the apparatus, i.e., the treatment device, via a first transport device 62, such as, in particular, but not exclusively, a transport starwheel. The plastic containers 15 are transported away via a second transport device 64.

Reference sign 7 designates a pressure supply device, such as a compressor or also a compressed-air connection. The compressed air is conveyed via a connecting line 72 to a rotary distributor 74 and from there passed on via an additional line 76 to a compressed air reservoir 2a, which preferably is an annular channel. Thus, preferably, such rotary distributor serves the purpose of feeding air from a stationary part of the apparatus into a rotating part of the apparatus.

In addition to such annular channel 2a shown, further annular channels are preferably provided, which are, however, concealed by, e.g., lie underneath, the annular channel 2a in the illustration shown in FIG. 1. Reference sign 32 designates a connecting line which delivers the pressurized air to a forming station 4 or its valve block 90. Preferably, each of the annular channels is connected to all forming stations via corresponding connecting lines. Such connecting line is preferably arranged in the rotating part of the apparatus.

Reference sign 8 schematically designates an optional clean room, which is preferably formed here in the shape of a ring and surrounds the transport path of the plastic preforms 10. Preferably, a (geometric) axis of rotation with respect to which the transport carrier 22 is rotatable is arranged outside the clean room 8. Preferably, the clean room is sealed from the non-sterile environment by a sealing device, which preferably has at least two surge tanks.

Furthermore, the apparatus has a cover device (not shown in FIG. 1), which delimits the clean room 8 upwards. This cover device is preferably arranged on at least one of the stretching devices 30.

The apparatus has a plurality of measuring and/or sensor devices which serve to control the apparatus. Reference sign 14 designates a pressure-measuring device which measures an air pressure within the compressed air reservoir 2a. The other compressed air reservoirs also preferably have corresponding pressure-measuring devices.

Reference sign 16 designates a further pressure-measuring device which measures an air pressure—in particular, a container interior pressure of the plastic preform to be expanded. Preferably, such a pressure-measuring device is assigned to each forming station.

Reference sign 18 also schematically designates a flow measuring device, which determines a flow rate of the blown air from a compressed air reservoir to the valve block 90 of a forming station 4. Preferably, corresponding flow-measuring devices are each arranged between a compressed air reservoir and all forming stations.

Additional flow measurement devices can also be assigned between the other compressed air reservoirs and the respective forming stations.

Furthermore, position-detection devices are preferably also provided which can detect positions of the stretching rods of the individual forming stations.

Reference sign 24 designates a control device which controls and in particular regulates the apparatus 1. This control device is preferably also able to change working parameters of the apparatus. Preferably, this control device is also suitable and intended to control a heating device 25, which heats the plastic preforms to be formed.

Preferably, the aforementioned measuring or sensor devices continuously output sensor or measurement data, which are particularly preferably stored. On the basis of this measurement or sensor data, for example, an AI can determine ideal working parameters for operating the treatment device 1.

The control device accordingly controls in particular the individual valves and hence the application to the plastic preforms with the individual pressure levels. In addition, the control device preferably also controls a movement of the stretching rods of the individual forming stations. Preferably, the control device also controls movements of the application devices, i.e., the blowing nozzles. The control device is therefore preferably suitable for controlling the points in time at which the application devices are applied to the plastic preforms and/or the points in time at which the blow-molding devices are again lifted from the plastic preforms, and in particular also for changing these points in time.

Reference sign 26 designates a memory device in which in particular measured variables are detected—in particular, pressure values and flow values, but also corresponding working parameters. Preferably, these respective values are saved with a temporal assignment.

These values can preferably be saved continuously and in particular over long periods of machine operation. The control device controls or regulates the apparatus, also taking into account these recorded measurement values.

Reference sign 28 roughly schematically designates an inspection device for inspecting the manufactured containers. Preferably, an assignment device is also provided which is suitable and intended for assigning to a specific inspected container those working parameters which were used to produce this container. Preferably, this inspection device is also suitable and intended for inspecting the support rings of the individual plastic containers.

Reference sign 13 schematically designates a sensor device that is suitable and intended for recording environmental data, such as an ambient temperature or an ambient pressure. These determined values are also preferably used in the control of the plant.

Reference sign 27 designates a display device that serves for outputting information to a machine operator. Using this display device, measured pressure (characteristic) curves can be output, for example. It would also be possible to use this display device to output values that are characteristic of the physical properties of the support rings of plastic preforms or plastic containers.

Reference sign 52 designates a transport device, by which blown plastic containers are transported to a filling device 40. Thus, this filling device is a further treatment device. This filling device 40 is followed by a closing device 42, which is suitable and intended for providing the containers filled by the filling device with container closures. Reference sign 44 designates a transport device that transports the filled and closed containers away.

Reference sign 9 schematically designates an inspection device that is suitable and intended for inspecting the filled plastic containers provided with the container closures and, in particular, for determining the aforementioned characteristic physical value for the support ring of the plastic containers.

As mentioned above, this value is preferably used in order to control and in particular regulate the forming device.

Reference sign 54 designates an optional rejection device which serves to reject plastic containers found to be defective during an inspection. Reference sign 56 designates a generating device for generating identification information.

On the basis of this identification, a rejected container and/or at least one information linked to this container, such as the point in time at which it was rejected, can be stored.

On the basis of this identification information, it can also be determined, for example, by which forming station 4 and/or with which operating parameters this rejected container was treated. It is also possible to determine the environmental conditions that existed at the point in time of rejection.

If applicable, this identification information and, in particular, a point in time can be used to also identify further containers that were formed with the same forming station in the same time period. In this way, the container can also be assigned values that were detected with the inspection device for such containers.

Preferably, a further rejection device (not shown) is provided which serves for rejecting plastic preforms to be inspected from the transport path.

Reference sign 25 designates a heating device that heats the plastic preforms to be formed by the forming device. This heating device has a transport device 17, which transports the plastic preforms to be heated while they are being heated. A plurality of holding devices 17a for holding the plastic preforms 10 are arranged on this transport device.

Reference sign 19 designates a blocking device that can block the entry of plastic preforms into the heating device.

Along the transport path of the plastic preforms to be heated, a plurality of (preferably stationary) heating devices 104 are arranged, each of which has a plurality of infrared radiators 144. Additionally or alternatively, laser or microwave emitters can also be provided. Reference sign 12 designates a transport device that transports further the heated plastic preforms from the heating device 25.

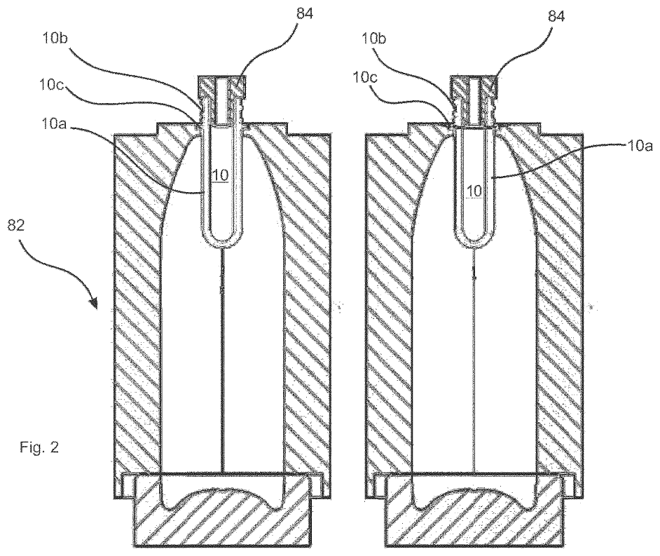

FIG. 2 is a representation for illustrating the problem of the invention. Two blow-molding devices 82 are shown, within which in each case a plastic preform 10 is arranged.

These plastic preforms each have a main body 10a, a mouth region 10b, and a support ring 10c. Reference sign 84 designates in each case a blowing nozzle that can be applied to the mouth regions of the plastic preforms 10, in order to expand them in their longitudinal direction.

In the situation shown in the left partial figure, the support ring 10c is intact and does not deform as a result of the blowing process. In the situation shown in the right partial figure, the support ring 10c and/or the region of the plastic preform is heated too much, which causes the support ring to deform or bend slightly upwards. In this case, faults occur in the further course of the production of the plastic containers and in particular during their transport.

The applicant reserves the right to claim all features disclosed in the application documents as essential to the invention, provided that they are novel with respect to the prior art individually or in combination. It is also pointed out that features which can be advantageous in themselves are also described in the individual figures. A person skilled in the art will immediately recognize that a particular feature described in a figure can be advantageous even without the adoption of further features from this figure. Furthermore, the person skilled in the art will recognize that advantages can also result from a combination of several features shown in individual or in different figures.

1. A method for producing plastic containers, wherein plastic preforms are transported along a predetermined transport path, and these plastic preforms have a main body, a mouth, and a support ring, and the main bodies of the plastic preforms are heated using at least one heating device, and, subsequently, the heated plastic preforms are transported to a forming device for forming plastic preforms into plastic containers and are formed into the plastic containers by applying a flowable medium,
wherein
at least one value is determined using an inspection device, which value is characteristic of at least one physical property of a support ring of a plastic preform and/or of a support ring of a plastic container, and at least one treatment parameter of the heating device and/or of the forming device is controlled taking this value into account.

2. The method according to claim 1,
wherein
the manufactured plastic containers are filled with a flowable medium and subsequently closed with a container closure.

3. The method according to claim 1,
wherein
the value characteristic of at least one physical property of a support ring of a plastic preform and/or of a plastic container is selected from a group of values characteristic of that comprise a direction of extension of the support ring relative to a longitudinal direction of the plastic preform, a wall thickness of the support ring, a curvature of the support ring, a concentricity of the support ring in relation to an axis of symmetry of the plastic preform, a distance of the support ring to a closure arranged on the plastic preform, a distance between the support ring and a thread of the plastic preform, and a distance between a reference point on the plastic container and a further reference point, wherein the further reference point is arranged in particular on the plastic container or on the container closure.

4. The method according to claim 1,
wherein
the inspection device has at least one image-recording device that records at least one image of a plastic container or a plastic preform to be inspected, in order to determine said value.

5. The method according to claim 1,
wherein
a closure is arranged on at least one plastic container, and at least one value is detected which is characteristic of a geometric relationship between the plastic container and the closure arranged on the plastic container.

6. The method according to claim 1,
wherein
at least one value characteristic of the operation of the heating device and/or the operation of the forming device is measured.

7. The method according to claim 6,
wherein
the characteristic environmental value is selected from a group of values which is an ambient temperature, an air humidity, an air pressure, a temperature of the plastic preforms prior to their heating, a temperature of the plastic preforms after their heating, a temperature of the plastic preforms during their heating, a degree of absorption of the plastic preforms, and a temperature profile of the plastic preforms with respect to their longitudinal direction and/or with respect to their circumferential direction.

8. The method according to claim 4,
wherein
at least one working parameter is assigned to the inspected container and/or the inspected plastic preform, by which this container and/or this plastic preform was treated.

9. The method according to claim 1,
wherein
a model is created which combines production data (working parameters and/or environmental data and/or measurement data) and the value characteristic of a property of the support ring of the plastic preform.

10. The method according to claim 8,
wherein
the working parameters are adjusted based upon the model, in order to achieve improved performance data and/or improved qualities of the support ring.

11. The method according to claim 1,
wherein
a plurality of containers are inspected, and a model for controlling the treatment device is derived from the measurement values determined during these inspections.

12. The method according to claim 1,
wherein
at least one target value or reference value is determined and compared with the value determined by the inspection device.

13. An apparatus for producing plastic containers, having a transport device that is configured for transporting plastic preforms along a predetermined transport path, wherein these plastic preforms have a main body, a mouth, and a support ring, and having a heating device that is configured for heating the main bodies of the plastic preforms, and having a forming device for forming plastic preforms into plastic containers, which is configured for forming the heated plastic preforms into the plastic containers by applying a flowable medium,
wherein
an inspection device is provided which is configured for determining at least one value that is characteristic of at least one physical property of the support ring of a plastic preform and/or of a plastic container, and a control device is provided which is configured for controlling at least one treatment parameter of the heating device and/or of the forming device, taking this value into account.

14. The apparatus according to claim 13,
wherein
the apparatus has at least one sensor device that is configured for measuring at least one value characteristic of the operation of the heating device and/or the operation of the forming device.

15. The apparatus according to claim 13,
wherein
the apparatus has a closing device configured for closing the containers, and the inspection device is arranged downstream of this closing device in a transport direction of the plastic containers.

16. The apparatus according to claim 13,
wherein
the apparatus has a comparison device that is configured for comparing the value with a target value and/or reference value.
